(19) United States
(12) Patent Application Publication
(10) Pub. No.: US 2019/0202169 A1
(43) Pub. Date: Jul. 4, 2019

(54) DOUBLE-SIDED TAPE WITH EXTENDED TEMPERATURE RANGE

(71) Applicants: Tsinghua University, Beijing (CN); HON HAI PRECISION INDUSTRY CO., LTD., New Taipei (TW)

(72) Inventors: XIANG JIN, Beijing (CN); Zi-Peng Wu, Beijing (CN); Wen-Tao Miao, Beijing (CN); KAI-LI JIANG, Beijing (CN); SHOU-SHAN FAN, Beijing (CN)

(21) Appl. No.: 16/119,635

(22) Filed: Aug. 31, 2018

(30) Foreign Application Priority Data
Dec. 28, 2017 (CN) 201711465826.5

(51) Int. Cl. B32B 7/00; B32B 5/16; B32B 9/04; C09J 7/38; C09J 5/00

(52) U.S. Cl. CPC B32B 7/005; B32B 5/16; B32B 9/04; C09J 7/38; C09J 5/00; B82Y 30/00; B32B 2405/00; B32B 2250/05; C09J 2205/302; C09J 2400/10; B32B 2264/10

(57) ABSTRACT

A double-sided utility tape which is solvent-free and able to function in a greatly extended range of temperatures includes a carbon nanotube structure. The carbon nanotube structure includes a super-aligned carbon nanotube film. The super-aligned carbon nanotube film includes carbon nanotubes. The carbon nanotubes extend substantially along a same direction, and an extending direction of the carbon nanotubes is substantially parallel to two bonded surfaces of the double-sided tape.

### CROSS-REFERENCE TO RELATED APPLICATIONS

This application claims all benefits accruing under 35 U.S.C. § 119 from China Patent Application No. 201711465826.5, filed on Dec. 28, 2017, in the China Intellectual Property Office, the contents of which are hereby incorporated by reference. The application is also related to copending applications entitled, “BONDING METHOD OF FIXING AN OBJECT TO A ROUGH SURFACE”, filed ______ (Atty. Docket No. US72472). The application is also related to copending applications entitled, “BONDING METHOD USING A CARBON NANOTUBE STRUCTURE”, filed ______ (Atty. Docket No. US72474)

### FIELD

The present disclosure relates to double-sided tapes with extended temperature range.

### BACKGROUND

Double-sided tape is used for bonding two or more objects with minimal presence. However, there is room for improvement in the conventional double-sided tapes. For example, application temperature range of conventional double-sided tapes is narrow, functionality of conventional double-sided tapes may be significantly reduced or even lost at high or low temperatures. When the objects bonded by the conventional double-sided tapes need to be separated, the conventional double-sided tapes are difficult to remove from the bonded surfaces of the objects. Solvent or heating is often required to remove the conventional tapes for the bonded surfaces, however, the bonded surfaces may be easily damaged. Furthermore, conventional double-sided tapes contain organic solvents, which pollute the environment and can be poisonous.

### BRIEF DESCRIPTION OF THE DRAWINGS

Implementations of the present disclosure will now be described, by way of example only, with reference to the attached figures, wherein:

FIG. 1 is a view showing a vertical structure of one embodiment of a double-sided tape.

FIG. 2 is a scanning electron microscope (SEM) image showing one embodiment of a super-aligned carbon nanotube film.

FIG. 3 is a curve showing changes in the adhesion strength between two objects bonded by the double-sided tape with changing the temperature.

FIG. 4 is a scanning electron microscope (SEM) image showing one embodiment of a carbon nanotube structure comprising 8 layers of super-aligned carbon nanotube films.

FIG. 5 is a scanning electron microscope (SEM) image showing one embodiment of a carbon nanotube structure comprising 50 layers of super-aligned carbon nanotube films.

FIG. 6 is a perspective view showing a structure of one embodiment of a carbon nanotube structure, which includes at least two super-aligned carbon nanotube films.

FIG. 7 is a curve showing changes in surface tension of silicon wafers with respect to a number of super-aligned carbon nanotube layers in a carbon nanotube structure.

FIG. 8 is a curve showing changes in surface tension of a thermal silicon oxide wafer with respect to a number of super-aligned carbon nanotube layers in a carbon nanotube structure.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “include, but not necessarily limited to”; it specifically indicates open-ended inclusion or membership in the so-described combination, group, series, and the like.

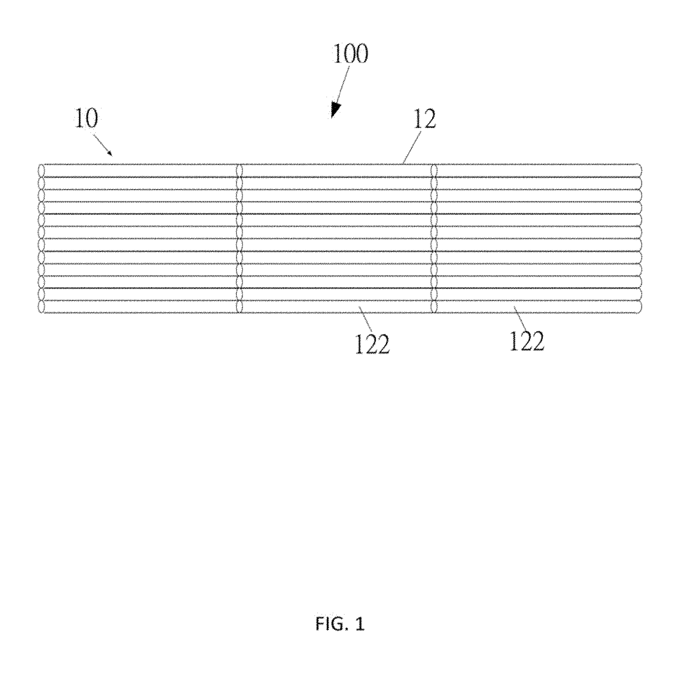

Referring to FIG. 1, one embodiment is described in relation to a double-sided tape 100. The double-sided tape 100 is used to bond two objects together. The double-sided tape 100 comprises a carbon nanotube structure 10. The carbon nanotube structure 10 comprises at least one super-aligned carbon nanotube film 12. The super-aligned carbon nanotube film 12 comprises a plurality of carbon nanotubes 122. The plurality of carbon nanotubes 122 extends substantially along the same direction. The extending direction of the plurality of carbon nanotubes 122 is substantially parallel to a surface of the super-aligned carbon nanotube film 12. The extending direction of the plurality of carbon nanotubes 122 is substantially parallel to two bonded surfaces of the double-sided tape.

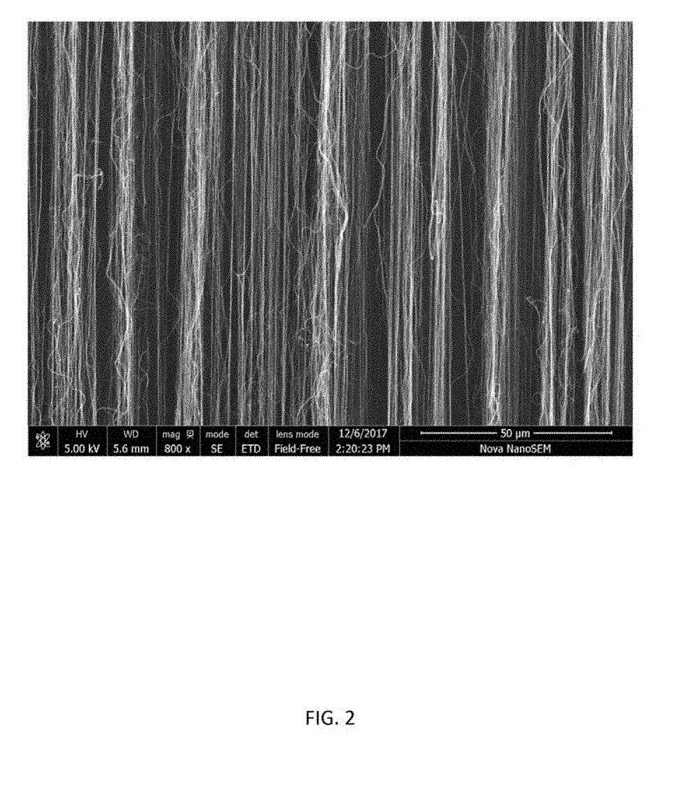

Referring to FIG. 2, the plurality of carbon nanotubes 122 extends substantially along the same direction refers to a majority of the carbon nanotubes in the super-aligned carbon nanotube film 12 extends along the same direction. A minority of carbon nanotubes may be randomly aligned. However, the number of randomly aligned carbon nanotubes is very small and does not affect the overall oriented alignment of the majority of carbon nanotubes in the super-aligned carbon nanotube film 12. The randomly aligned carbon nanotubes can be effectively ignored. The plurality of carbon nanotubes in the super-aligned carbon nanotube film 12 are joined end-to-end by van der Waals force. Adjacent carbon nanotubes along the extending direction are joined end-to-end by van der Waals force.

In one embodiment, the plurality of carbon nanotubes is pure carbon nanotubes. Pure carbon nanotubes are carbon nanotubes that are not modified by physical or chemical methods, include few or no impurities adhered on surfaces of the carbon nanotubes, and have a purity of the carbon nanotubes that is larger than or equal to 99.9%. The carbon nanotube structure 10 contains no organic solvents.

Since the plurality of carbon nanotubes 122 is pure carbon nanotubes, and a specific surface area of each of the plurality of carbon nanotubes 122 is very large, the super-aligned carbon nanotube film 12 has a strong stickiness. The carbon nanotube structure 10 therefore has strong stickiness. Therefore, two objects can be well bonded together by the double-sided tape 100 comprising the carbon nanotube structure 10.

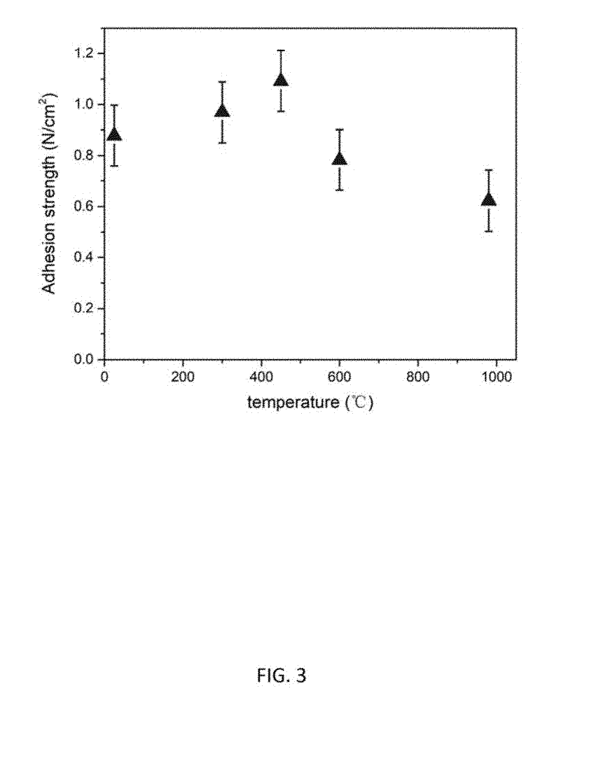

The absence or almost complete absence of impurities adhered on surfaces of the plurality of carbon nanotubes 122, such as amorphous carbon or residual catalyst metal particles, provides high thermal stability for the super-aligned carbon nanotube film 12, and the super-aligned carbon nanotube film 12 is not easily oxidized even at high temperatures. Furthermore, the double-sided tape 100 comprising the carbon nanotube structure 10 is bonded to the objects only through van der Waals force and temperature has minor effects on Van der Waals force. Therefore, the double-sided tape 100 comprising the carbon nanotube structure 10 still has excellent stickiness at high and low temperatures, for example, the double-sided tape 100 still has excellent stickiness at about −196° C. and at about 1000° C. An application temperature range of the double-sided tape 100 is wide. Referring to FIG. 3, the adhesion strength between two objects bonded by the double-sided tape 100 minor changes with changing the temperature. In one embodiment, the application temperature range of the double-sided tape 100 is from about −196° C. to about 1000° C. In one embodiment, the application temperature range of the double-sided tape 100 is from about −196° C. to about −100° C. In one embodiment, the application temperature range of the double-sided tape 100 is from about 500° C. to about 1000° C. In another embodiment, the application temperature range of the double-sided tape 100 is from about 800° C. to about 1000° C.

The super-aligned carbon nanotube film 12 is a free-standing film. The term ‘free-standing’ includes films that do not have to be supported by a substrate, and are self-supporting to maintain a film shape. Therefore, the carbon nanotube structure 10 comprising the super-aligned carbon nanotube film 12 can be directly laid on a bonded surface to bond with it.

The super-aligned carbon nanotube film 12 can be obtained by drawing from a super-aligned carbon nanotube array. An arranged direction of the plurality of carbon nanotubes in the super-aligned carbon nanotube film 12 is substantially parallel to a drawing direction of the super-aligned carbon nanotube film 12. The plurality of carbon nanotubes in the super-aligned carbon nanotube film 12 is pure. In one embodiment, a length of each of the plurality of carbon nanotubes 122 is longer than 300 micrometers.

The super-aligned carbon nanotube array can be made by chemical vapor deposition (CVD), an arc discharge preparation method, or an aerosol preparation method. In one embodiment, the super-aligned carbon nanotube array is obtained by chemical vapor deposition (CVD). The chemical vapor deposition (CVD) method comprises BLOCK (A) of providing a substrate, wherein the substrate can be a P-type silicon substrate, an N-type silicon substrate, or a silicon substrate formed with an oxide layer. BLOCK (B) of forming a catalyst layer on a surface of the substrate, wherein a material of the catalyst layer can be selected from the group consisting of iron (Fe), cobalt (Co), nickel (Ni), and alloy of any combination thereof. BLOCK (C) of annealing the substrate with the catalyst layer in air at 700° C. to 900° C. for about 30 minutes to 90 minutes and BLOCK (D) of placing the substrate in a reaction chamber, heating the reaction chamber in protective gas to 500° C.˜740° C., introducing a carbon source gas into the reaction chamber for about 5 minutes to about 30 minutes, and growing the super-aligned carbon nanotube array from the substrate. A height of the carbon nanotube of the super-aligned carbon nanotube array ranges from about 200 micrometers to about 400 micrometers. The carbon source gas can be chemically active hydrocarbons, such as acetylene. The protective gas can be nitrogen, ammonia, or inert gas.

A method of drawing the super-aligned carbon nanotube film 12 from the super-aligned carbon nanotube array comprises block (a) of selecting carbon nanotube segments with a certain width from the super-aligned carbon nanotube array and, at a certain speed, and block (b) of stretching the carbon nanotube segments to be substantially perpendicular to a growth direction of the super-aligned carbon nanotube array. Thus, the super-aligned carbon nanotube film 12 is obtained.

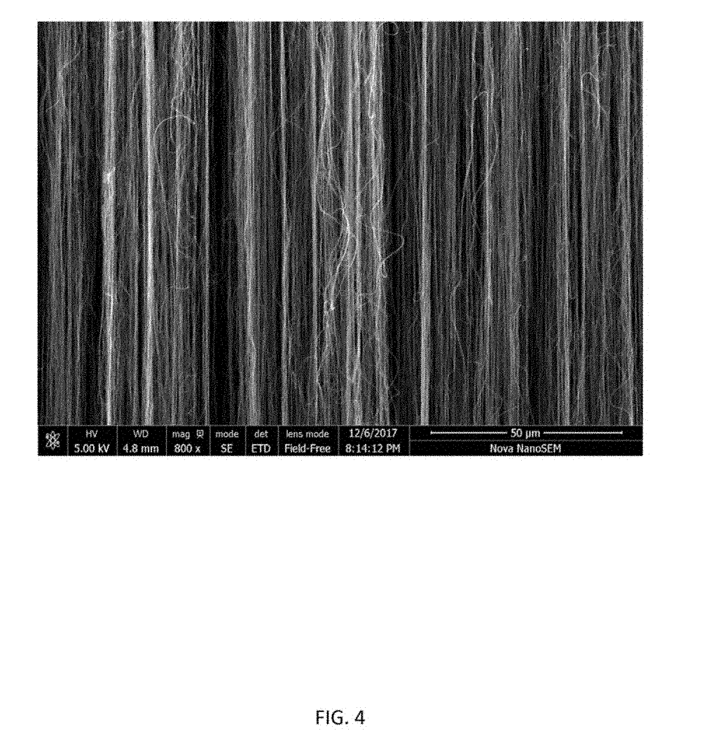

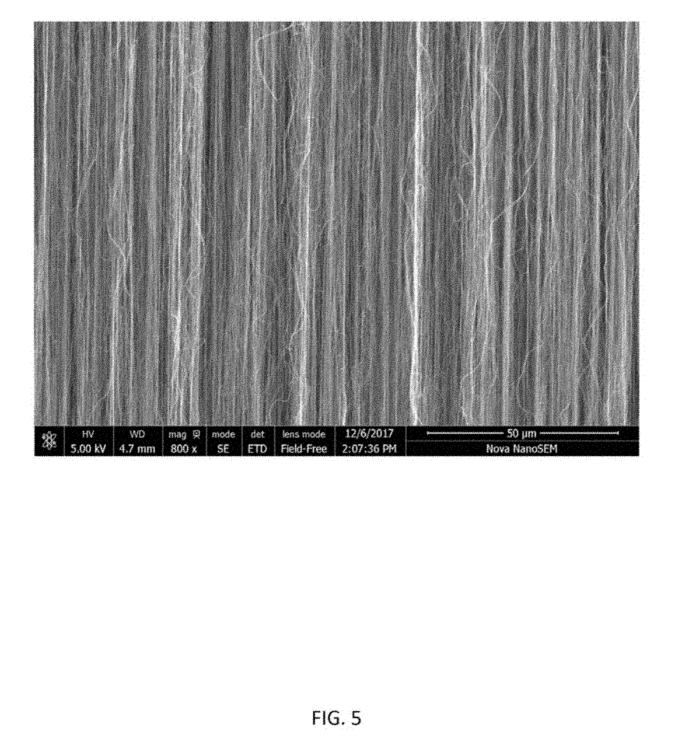

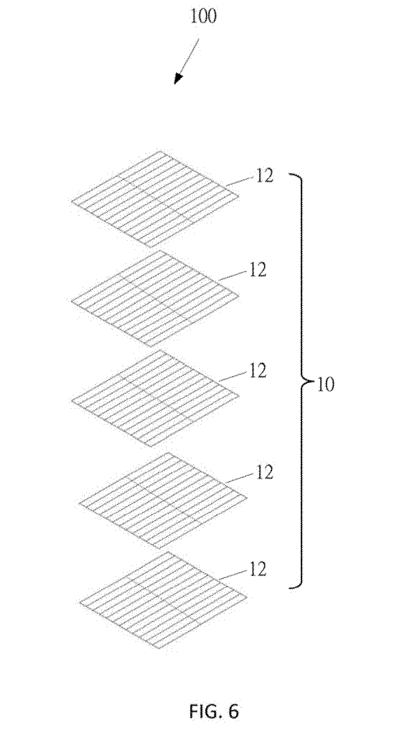

Referring to FIGS. 4-6, in one embodiment, the carbon nanotube structure 10 comprises at least two super-aligned carbon nanotube films 12. The at least two super-aligned carbon nanotube films 12 overlap and are parallel to each other. Adjacent super-aligned carbon nanotube films 12 are closely joined by van der Waals force. The extending directions of the plurality of carbon nanotubes of the at least two super-aligned carbon nanotube films 12 are substantially the same. Substantially the same, for example, refers to a majority of the carbon nanotubes in the at least two super-aligned carbon nanotube film 12 that extend along the same direction, and only a minority of carbon nanotubes are randomly aligned. The randomly aligned carbon nanotubes do not affect the overall extending direction of most of the carbon nanotubes in the carbon nanotube structure 10.

The number of the super-aligned carbon nanotube films 12 in the carbon nanotube structure 10 can be selected according to actual needs. In one embodiment, the carbon nanotube structure 10 comprises 5 to 30 layers of the super-aligned carbon nanotube films 12 overlap and parallel to each other. In one embodiment, the carbon nanotube structure 10 comprises 10 to 15 layers of the super-aligned carbon nanotube films 12 overlap and parallel to each other. In another embodiment, the carbon nanotube structure 10 comprises 10 layers of the super-aligned carbon nanotube films 12 overlap and parallel to each other.

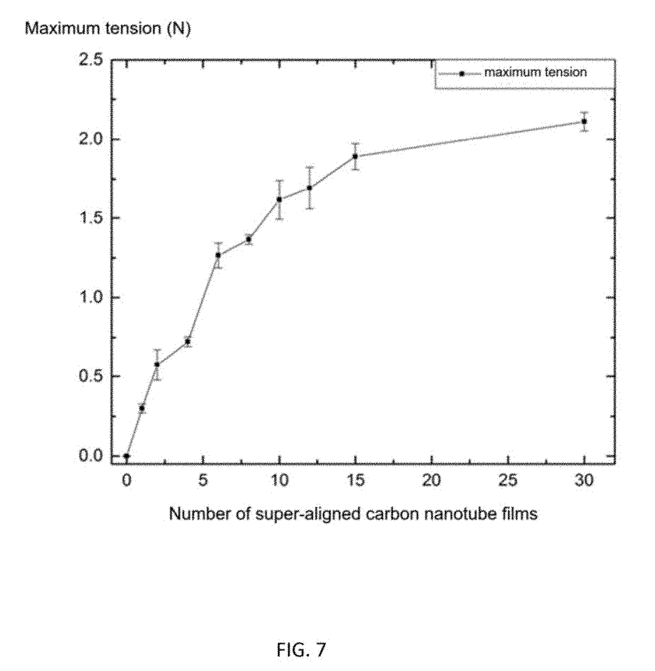

Referring to FIG. 7, test results of different double-sided tapes, comprising different numbers of super-aligned carbon nanotube films 12, bonded to two square silicon wafers with a side length of 7 mm are shown. When no super-aligned carbon nanotube film 12 are arranged between the two square silicon wafers, no adhesion is present between the two square silicon wafers. As the number of the super-aligned carbon nanotube films 12 in the carbon nanotube structure 10 increases, the adhesion between the two square silicon wafers also increases. When the number of the super-aligned carbon nanotube films 12 in the carbon nanotube structure 10 is greater than 15 layers, a rate of increase of the adhesion between the two square silicon wafers decreases with the increase in the number of the super-aligned carbon nanotube films 12.

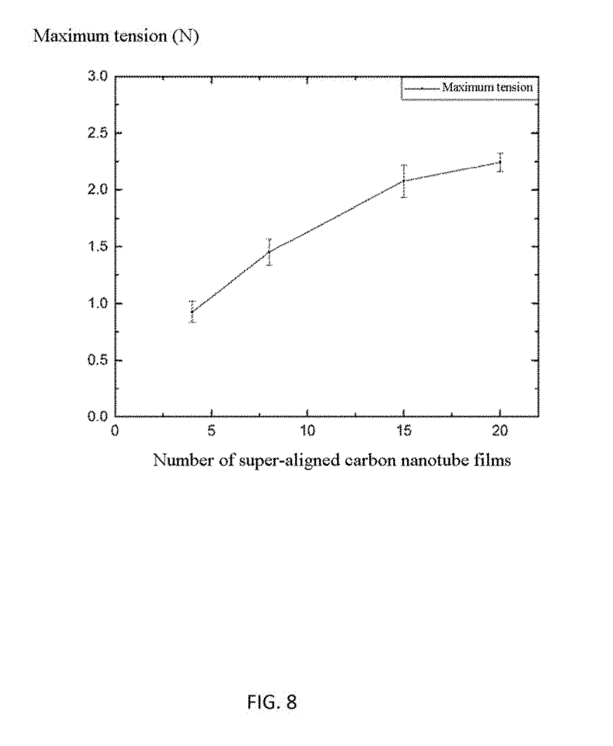

Referring to FIG. 8, test results of different double-sided tapes comprising different numbers of super-aligned carbon nanotube films 12, bonded to a silicon wafer and a thermal silicon oxide wafer (SiO₂). Notably, increasing the number of the super-aligned carbon nanotube film 12 in the carbon nanotube structure 10 causes greater adhesion between the silicon wafer and the thermal silicon oxide wafer. When the number of the super-aligned carbon nanotube films 12 in the carbon nanotube structure 10 is larger than 15 layers, an increase rate of the adhesion between the silicon wafer and the thermal silicon oxide wafer decreases with the increase in the number of layers of the super-aligned carbon nanotube films 12.

The double-sided tape 100 comprising the carbon nanotube structure 10 is bonded to the object only by van der Waals force. If the bonded surface of the object is too rough or the bonded surface is not clean, the van der Waals force between the double-sided tape 100 and the bonded surface decreases, and thus the adhesion between the double-sided tape 100 and the bonded object would decrease as well. In some embodiments, the double-sided tape 100 is used for bonding an object having a clean and smooth surface, that is, the bonded surface of the bonded object is the clean and smooth surface. The term “clean and smooth surface” refers the surface being substantially free of impurities and has a small degree of surface roughness. In one embodiment, the surface roughness of the bonded surface is less than or equal to about 1.0 micrometer. In one embodiment, the surface roughness of the bonded surface is less than or equal to about 500 nanometers. In one embodiment, the surface roughness of the bonded surface is less than or equal to about 100 nanometers.

The object can be a glass, a quartz plate, a silicon wafer, a polyethylene terephthalate (PET) sheet, or the like. The double-sided tape 100 is bonded to the object only by van der Waals force. When the objects need to be separated from each other, the objects can be separated from each other only by a force without heating or dissolving with solvent, and the double-sided tape 100 can be removed from the bonded surfaces without causing damage to the bonded surfaces after the objects are separated from each other. When the double-sided tape 100 is used, a bonding position can be adjusted.

In one embodiment, the carbon nanotube structure 10 consists of at least one super-aligned carbon nanotube film 12, and each of the super-aligned carbon nanotube film 12 consists of a plurality of carbon nanotubes. The plurality of carbon nanotubes extend substantially along a same direction and are joined end-to-end by van der Waals force.

In one embodiment, the carbon nanotube structure 10 comprises a plurality of carbon nanotubes. The plurality of carbon nanotubes are joined end-to-end by van der Waals force and extend substantially along a same direction, and an extending direction of the plurality of carbon nanotubes is parallel to a length direction of the double-sided tape 100. The plurality of carbon nanotubes can be pure carbon nanotubes. The pure carbon nanotubes are basically carbon nanotubes that are not modified by physical or chemical processes, where few or no impurities are adhered on surface of the carbon nanotubes, and a purity of the carbon nanotubes is larger than or equal to 99.9%.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A double-sided tape comprising a carbon nanotube structure and two bonded surfaces, wherein the carbon nanotube structure comprises a super-aligned carbon nanotube film, the super-aligned carbon nanotube film comprises a plurality of carbon nanotubes, the plurality of carbon nanotubes extend substantially along an extending direction, the extending direction is substantially parallel to the two bonded surfaces.

2. The double-sided tape of claim 1, wherein an application temperature range of the double-sided tape is from about −196° C. to about 1000° C.

3. The double-sided tape of claim 2, wherein the application temperature range of the double-sided tape is from about −196° C. to about −100° C.

4. The double-sided tape of claim 2, wherein the application temperature range of the double-sided tape is from about 500° C. to about 1000° C.

5. The double-sided tape of claim 1, wherein the plurality of carbon nanotubes are pure carbon nanotubes.

6. The double-sided tape of claim 5, wherein a purity of the plurality carbon nanotubes is larger than or equal to 99.9%

7. The double-sided tape of claim 1, wherein the double-sided tape contains no organic solvent.

8. The double-sided tape of claim 1, wherein the double-sided tape is bonded to an object only by van der Waals force.

9. The double-sided tape of claim 1, wherein the carbon nanotube structure comprises at least two super-aligned carbon nanotube films overlap and parallel to each other.

10. The double-sided tape of claim 9, wherein the carbon nanotube structure comprises 5 to 30 layers of the super-aligned carbon nanotube films overlap and parallel to each other.

11. The double-sided tape of claim 10, wherein the carbon nanotube structure comprises 10 to 15 layers of the super-aligned carbon nanotube films overlap and parallel to each other.

12. The double-sided tape of claim 1, wherein the double-sided tape is configured to bond an object having a surface roughness less than or equal to about 1.0 micrometer.

13. The double-sided tape of claim 1, wherein the carbon nanotube structure consists of the super-aligned carbon nanotube film, and the super-aligned carbon nanotube film consists of the plurality of carbon nanotubes.

14. The double-sided tape of claim 1, wherein two objects bonded together by the double-sided tape are separable from each other only by a force without heating or dissolving with solvent, and the double-sided tape is removable from the two objects without causing damage to the two objects after the two objects are separated from each other.

15. A double-sided tape comprising a plurality of carbon nanotubes, wherein the plurality of carbon nanotubes extend substantially along an extending direction and are joined end-to-end by van der Waals force; and the extending direction is parallel to two opposite bonded surfaces of the double-sided tape.

16. The double-sided tape of claim 15, wherein an application temperature range of the double-sided tape is from about −196° C. to about 1000° C.

17. A carbon nanotube structure for application as a double-sided tape, wherein the carbon nanotube structure is configured to bond two objects, the carbon nanotube structure comprises at least one super-aligned carbon nanotube film, each of the at least one super-aligned carbon nanotube film comprises a plurality of carbon nanotubes, the plurality of carbon nanotubes extends substantially along an extending direction and are joined end-to-end by van der Waals force; and the extending direction of the plurality of carbon nanotubes is parallel to two opposite bonded surfaces of the carbon nanotube structure.
